(19) United States
(12) Patent Application Publication
(10) Pub. No.: US 2020/0357597 A1
(43) Pub. Date: Nov. 12, 2020

(54) COLD CATHODE X-RAY TUBE AND CONTROL METHOD THEREFOR

(71) Applicants: NANO-X IMAGING LTD., Chiyoda-ku Tokyo (IL); NANOX JAPAN, INC., Tokyo (JP)

(72) Inventor: KENMOTSU HIDENORI, TOKYO (JP)

(21) Appl. No.: 16/966,050

(22) PCT Filed: Jan. 29, 2019
(86) PCT No.: PCT/JP2019/002967

§ 371 Date: Jul. 30, 2020

Related U.S. Application Data
(60) Provisional application No. 62/624,314, filed on Jan. 31, 2018.

(51) Int. Cl. H01J 35/06; H01J 35/20; H01J 35/16

(52) U.S. Cl. CPC H01J 35/065; H01J 35/16; H01J 35/20

(57) ABSTRACT

The object of the present invention is to provide a cold cathode X-ray tube capable of being driven stably over a long period of time by preventing temporal reduction in anode current. A cold cathode X-ray tube 1 comprises an electron emission part 10 including an electron emission element using a cold cathode, an anode part 11 disposed opposite to the electron emission part 10, a target 12 disposed on a part of a surface of the anode part 11, a housing 15 in which the electron emission part 10, the anode part 11, and the target 12 are disposed, and a hydrogen generation part 14 that is made of a material that generates hydrogen when receiving collision of electrons and disposed on a portion other than the surface of the target 12 out of surfaces existing in the housing 15.

### TECHNICAL FIELD

The present invention relates to a cold cathode X-ray tube and a control method therefor.

### BACKGROUND ART

Conventional X-ray tubes use a filament as an electron emission element and use thermoelectrons emitted from the filament as an electron source. On the other hand, there are recently proposed some X-ray tubes (cold cathode X-ray tubes) that use a cold cathode as an electron emission element (e.g., U.S. Pat. No. 7,778,391, U.S. Pat. No. 7,809,114, and U.S. Pat. No. 7,826,595).

As compared to the X-ray tubes that use a filament as an electron emission element, the cold cathode X-ray tubes have a property that the electron emission amount thereof is subject to cathode surface conditions. Therefore, in conventional cold cathode X-ray tubes, there may occur such a problem that a vacuum degree is lowered by gas generated during the operation of the X-ray tube to change the cathode surface conditions to cause temporal reduction in anode current. In order to solve this problem, there is known a method that gradually increases extraction voltage (e.g., Non-Patent Documents 1 and 2).

Non-Patent Document 3 describes, as an example of field emission display, that in a Spindt-type cold cathode array using a Mo material, temporal reduction in anode current occurs due to generation of oxidizing gas in a vacuum tube being in an operating state. Further, Non-Patent Document 4 describes that hydrogen gas is effective for preventing such reduction in anode current. In the technique described in Non-Patent Document 4, a metal hydride is disposed in the flow of electrons (primary electrons) directed from the cathode to anode, and hydrogen gas is generated when the electrons collide with the metal hydride.

### CITATION LIST

### Patent Document

| | |
|---|---|
| Patent Document 1 | U.S. Pat. No. 7,778,391 |
| Patent Document 2 | U.S. Pat. No. 7,809,114 |
| Patent Document 3 | U.S. Pat. No. 7,826,595 |

### Non-Patent Document

Non-Patent Document 1 IVNC2013 P15 Stable, High Current Density Carbon Nanotube Field Emission Devices (D. Smith et. al). Proc. Of SPIE Vol.7622 76225M-1 Distributed source X-ray technology for Tomosynthesis imaging (F. Sprenger, et.al)

Non-Patent Document 2 Proc. Of SPIE Vol.7622 76225M-1 Distributed source X-ray technology for Tomosynthesis imaging (F. Sprenger, et.al)

Non-Patent Document 3 J. Vac. Sci. Technol. B 16, 2859 (1998) Effect of 02 on the electron emission characteristics of active molybdenum field emission cathode arrays (B. Chalamala, et.al)

Non-Patent Document 4 J. Vac. Sci. Technol. B 21, 1187 (2003) Gas-induced current decay of molybdenum field emitter arrays (R. Reuss, et.al)

### SUMMARY OF THE INVENTION

### Technical Problem to be Solved by Invention

However, it is difficult for the above-described conventional techniques to sufficiently suppress the temporal reduction in anode current generated in the cold cathode X-ray tube. That is, in the method that gradually increases the extraction voltage, discharge is generated when the extraction voltage becomes excessively high, so that the temporal reduction in anode current cannot be sufficiently covered. Further, in the method utilizing the hydrogen gas, it is necessary to apply coating of the metal hydride onto a target in order to dispose the metal hydride in the flow of electrons (primary electrons) directed from the cathode to anode; otherwise this method cannot be applied to the cold cathode X-ray tube. Hereinafter, this point will be described in greater detail.

In the X-ray tube, a target as an X-ray generation source is disposed on a part of the anode surface with which the flow of electrons (primary electrons) directed from the cathode to anode directly collides. Therefore, it is necessary to apply coating of the metal hydride to the target in order to dispose the metal hydride in the flow of electrons (primary electrons) directed from the cathode to anode.

However, the target needs to be subjected to high-temperature baking treatment. Application of such baking treatment will cause hydrogen to desorb from the metal hydride, so that it is difficult to apply coating of the metal hydride onto the target for the purpose of generating hydrogen gas. Further, the target has a high temperature even during the operation of the X-ray tube, so that even if the target can be coated with the metal hydride, film peeling or cracks may occur in the metal hydride due to high temperature during the operation, thus preventing the metal hydride from playing a role as a hydrogen gas supply source.

It is therefore an object of the present invention to provide a cold cathode X-ray tube capable of being driven stably over a long period of time by preventing temporal reduction in anode current.

### Means for Solving Problem

A cold cathode X-ray tube according to the present invention includes; an electron emission part including an electron emission element using a cold cathode; an anode part disposed opposite to the electron emission part; a target disposed on a part of a surface of the anode part; a housing in which the electron emission part, the anode part, and the target are disposed; and a hydrogen generation part that is made of a material that generates hydrogen when receiving collision of electrons and disposed on a portion other than the surface of the target out of surfaces existing in the housing.

### ADVANTAGEOUS EFFECTS OF INVENTION

In the cold cathode X-ray tube, scattering electrons collide also with a part of the anode surface other than a part thereof with which the flow of electrons directed from the cathode to anode directly collides (including other surfaces existing inside the housing), so that according to the present invention, even though the hydrogen generation part is disposed on a portion other than the target surface, hydrogen gas can be generated while the X-ray tube is being operated. Thus, the temporal reduction in the anode current can be prevented, allowing a cold cathode X-ray tube capable of being driven stably over a long period of time to be provided.

### BRIEF DESCRIPTION OF DRAWINGS

FIG. 1A is a schematic cross-sectional view of a cold cathode X-ray tube 1 according to an embodiment of the present invention, and FIG. 1B is a schematic cross-sectional view of the electron emission part 10.

FIG. 2 is a view schematically illustrating the temporal change in the anode current of the cold cathode X-ray tube.

FIG. 3 is a schematic cross-sectional view of the cold cathode X-ray tube 1 according to a first modification of the embodiment of the present invention.

FIG. 4 is a schematic cross-sectional view of the cold cathode X-ray tube 1 according to a second modification of the embodiment of the present invention.

### DETAILED DESCRIPTION

### Mode for Carrying out the Invention

Preferred embodiments of the present invention will be explained below in detail with reference to the accompanying drawings.

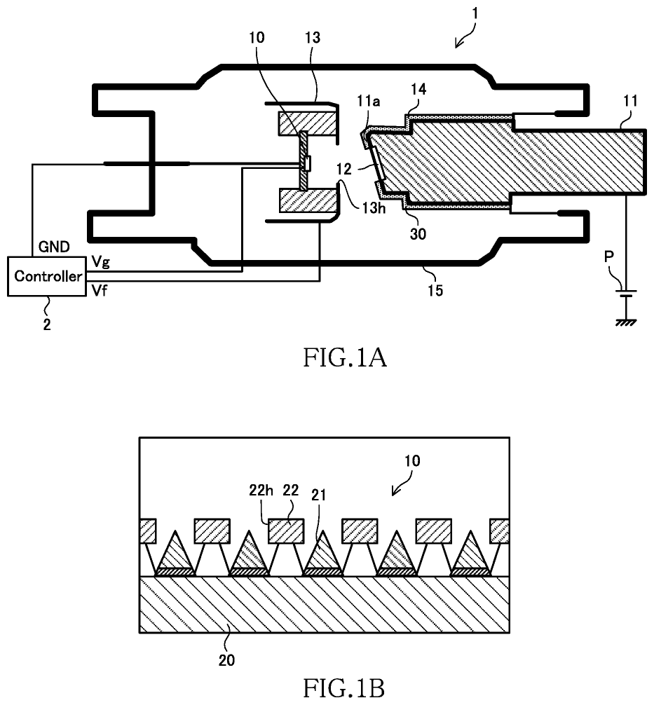

FIG. 1A is a schematic cross-sectional view of a cold cathode X-ray tube 1 according to an embodiment of the present invention. As illustrated, the X-ray tube 1 has a structure in which an electron emission part 10, an anode part 11, a target 12, a focus structure 13, and a hydrogen generation part 14 are disposed inside a housing 15. FIG. 1 also illustrates a controller 2 for the X-ray tube 1.

The housing 15 is a sealed member made of glass, ceramic, or stainless. Although not illustrated, a valve is provided in the housing 15, and exhaust of gas from the housing 15 and injection of gas into the housing 15 are performed as needed through the valve. For example, before the cold cathode X-ray tube 1 is operated under the control of the controller 2, a vacuum pump is used to exhaust the gas from the housing 15 to form a vacuum state, and, meanwhile, hydrogen gas or a mixture of hydrogen gas and nitrogen gas is injected into the housing 15 to adsorb the hydrogen gas to the hydrogen generation part 14. This is treatment for suitably generating the hydrogen gas from the hydrogen generation part 14.

FIG. 1B is a schematic cross-sectional view of the electron emission part 10. As illustrated, the electron emission part 10 includes a cathode part 20, a plurality of electron emission elements 21 disposed on the upper surface of the cathode part 20, and a gate electrode 22 having a plurality of matrix-arranged openings 22h. Each of the plurality of electron emission elements 21 is a Spindt-type cold cathode and disposed in each of openings 22h. The upper end of each of the electron emission elements 21 is positioned within each opening 22h. The cathode part 20 is supplied with a ground potential GND from the controller 2, and the gate electrode 22 is supplied with gate voltage Vg from the controller 2.

The anode part 11 is a metal member having an anode surface 11a disposed opposite to the electron emission part 10 and, specifically, the anode part 11 is made of copper (Cu). The anode part 11 is connected with the positive side terminal of a power supply P. Thus, when the gate electrode 22 illustrated in FIG. 1B is turned ON, current (anode current) flows from the power supply P through the anode part 11, electron emission part 10, and cathode part 20. At this time, a plurality of electrons (primary electrons) are emitted from the electron emission elements 21 illustrated in FIG. 1B. These electrons collide with the anode surface 11a, pass through the anode part 11, and are absorbed by the power supply P. As illustrated in FIG. 1A, the anode surface 11a is inclined to the electron moving direction (direction from the left to the right in FIG. 1A).

The target 12 is a member made of a material that generates an X-ray by receiving electrons and disposed so as to cover a part of the anode surface 11a with which the electrons emitted from the electron emission elements 21 directly collide. Since the target 12 is disposed on the anode surface 11a, some or all of the plurality of electrons that collide with the anode surface 11a pass through the target 12, and an X-ray is generated in the target 12 during the passage. The thus generated X-ray is radiated downward in the drawing due to inclination of the anode surface 11a.

The focus structure 13 is a structure having a function of correcting the trajectory of the electrons emitted from the electron emission part 10 and is disposed between the electron emission part 10 and the target 12 disposed on the anode surface 11a. The focus structure 13 has a window 13h. The electrons emitted from the electron emission part 10 are directed to the target 12 through the window 13h. The focus structure 13 is supplied with focus voltage Vf from the controller 2. The focus voltage Vf plays a role of controlling the amount of correction of the electron trajectory made by the focus structure 13. The focus structure 13 may be divided into two or more areas and, in this case, it is possible to adjust the focus position of an electron beam on the anode surface 11a by applying different focus voltages Vf to the respective areas.

The controller 2 is a processor that operates according to a previously written program or an external instruction and has functions of supplying the ground potential GND to the cathode part 20, supplying the gate voltage Vg to the gate electrode 22, and supplying the focus voltage Vf to the focus structure 13. The X-ray tube 1 is activated when the gate voltage Vg starts being supplied to the gate electrode 22 under the control of the controller 2 and starts X-ray emission.

The hydrogen generation part 14 is a member made of a material that generates hydrogen when receiving collision of electrons. Examples of such material include a silicon nitride film (SiN), a silicon carbide film (SiC), a silicon carbonitride film (SiCN), an amorphous carbon film (a-C), and a diamond-like carbon film (DLC).

The hydrogen generation part 14 is disposed on a portion other than the surface of the target 12 out of surfaces existing in the housing 15. Specifically, as illustrated in FIG. 1A, the hydrogen generation part 14 is disposed at a part of a metal surface constituting the anode part 11 where the target 12 is not disposed. The hydrogen generation part 14 may be disposed avoiding a part of the metal surface constituting the anode part 11 with which the primary electrons emitted from the electron emission part 10 directly collide.

The hydrogen generation part 14 is preferably formed by, e.g., plasma CVD (Plasma-Enhanced Chemical Vapor Deposition). The use of the plasma CVD allows the hydrogen generation part 14 to be constituted by a thin film covering a surface of a target. For example, when the hydrogen generation part 14 is constituted by a diamond-like carbon film (DLC), it is preferable to use plasma CVD using methane (CH4) as source gas to form a thin film of 1 □m at 1 Pa and at 200□C.

When the primary electrons emitted from the electron emission part 10 collide with the target 12 formed on the anode surface 11a, second electrons are emitted from the target 12 in addition to the X-ray. At least some of the secondary electrons go behind the target 12 and collide with the surface of the anode part 11. Since the hydrogen generation part 14 is disposed there, hydrogen gas is generated due to collision of the electrons. As a result, gas atmosphere (partial pressure) inside the housing 15 is adjusted, whereby the temporal reduction in the anode current can be prevented.

As described above, in the cold cathode X-ray tube 1 according to the present embodiment, the temporal reduction in the anode current can be prevented, allowing a cold cathode X-ray tube capable of being driven stably over a long period of time to be provided. Further, in the cold cathode X-ray tube 1 according to the present embodiment, the hydrogen generation part 14 is not formed on the surface of the target 12, so that it is possible to avoid that the hydrogen generation part 14 cannot accomplish its role as a hydrogen gas supply source due to occurrence of film peeling or cracks.

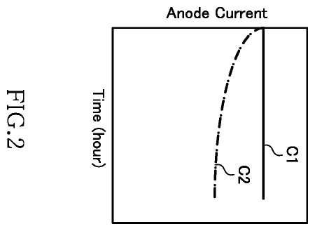

FIG. 2 is a view schematically illustrating the temporal change in the anode current of the cold cathode X-ray tube. In FIG. 2, the horizontal axis represents time, and the vertical axis represents the anode current. A curve C1 denotes a change in the anode current in the cold cathode X-ray tube 1 according to the present embodiment, and a curve C2 denotes a change in the anode current in a cold cathode X-ray tube obtained by removing the hydrogen generation part 14 from the cold cathode X-ray tube 1 according to the present embodiment.

As illustrated in FIG. 2, in the absence of the hydrogen generation part 14, the anode current reduces with the lapse of time; on the other hand, in the presence of the hydrogen generation part 14, constant anode current continues to flow even after the lapse of time. Thus, according to the present embodiment, it is possible to prevent the temporal reduction in the anode current by providing the hydrogen generation part 14.

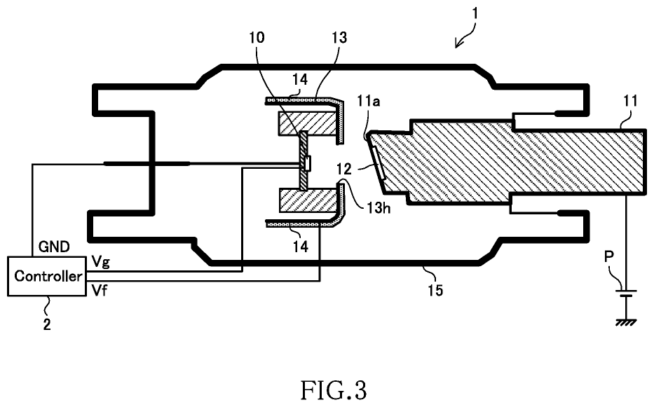

FIG. 3 is a schematic cross-sectional view of the cold cathode X-ray tube 1 according to a first modification of the embodiment of the present invention. In the present modification, the hydrogen generation part 14 is disposed not on the surface of the anode part 11 but on the focus structure 13. In this case, as illustrated in FIG. 3, the hydrogen generation part 14 is preferably disposed only on the surface of the focus structure 13 on the opposite side of the surface thereof facing the electron emission part 10, not on the entire surface of the focus structure 13. The material of the hydrogen generation part 14 and the forming method therefor may be the same as those when the hydrogen generation part 14 is formed on the surface of the anode part 11.

According to the present modification, some of the electrons emitted from the electron emission part 10 that scatter in the horizontal direction (backscattering electrons) collide with the hydrogen generation part 14. Thus, hydrogen gas is generated as in the case of the above embodiment, so that the temporal reduction in the anode current can be prevented according to the present modification as well, allowing a cold cathode X-ray tube capable of being driven stably over a long period of time to be provided. Further, it is possible to avoid the problem in that the hydrogen generation part 14 cannot accomplish its role as a hydrogen gas supply source due to the occurrence of film peeling or cracks.

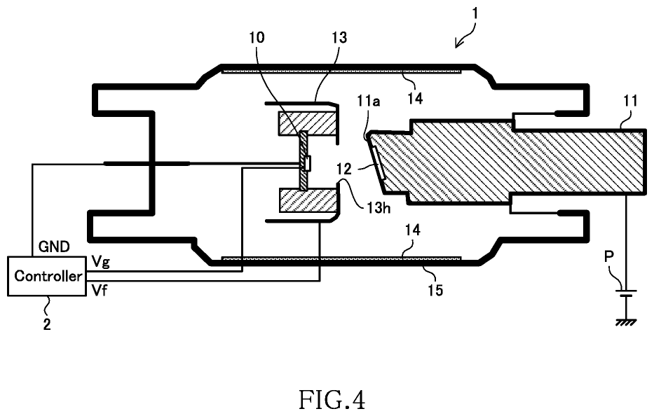

FIG. 4 is a schematic cross-sectional view of the cold cathode X-ray tube 1 according to a second modification of the embodiment of the present invention. In the present modification, the hydrogen generation part 14 is disposed not on the surface of the anode part 11 or the surface of the focus structure 13 but on a part of the inner wall of the housing 15. Specifically, as illustrated in FIG. 4, the hydrogen generation part 14 is formed over the entire periphery of the inner wall of a cylindrical part at the center of the housing 15. The material of the hydrogen generation part 14 and the forming method therefor may be the same as those when the hydrogen generation part 14 is formed on the surface of the anode part 11.

According to the present modification, some of the electrons emitted from the electron emission part 10 that scatter in the horizontal direction (backscattering electrons) collide with the hydrogen generation part 14. Thus, hydrogen gas is generated as in the case of the above embodiment and the first modification, so that the temporal reduction in the anode current can be prevented according to the present modification as well, allowing a cold cathode X-ray tube capable of being driven stably over a long period of time to be provided. Further, it is possible to avoid the problem in that the hydrogen generation part 14 cannot accomplish its role as a hydrogen gas supply source due to the occurrence of film peeling or cracks.

It is apparent that the present invention is not limited to the above embodiments, but may be modified and changed without departing from the scope and spirit of the invention.

### REFERENCE SIGNS LIST

1 cold cathode X-ray tube
2 controller
10 electron emission part
11 anode part
11a anode surface
12 target
13 focus structure
13h window
14 hydrogen generation part
15 housing
20 cathode part
21 electron emission element
22 gate electrode
22h opening
P power supply
T transistor

1. A cold cathode X-ray tube comprising:
an electron emission part including an electron emission element using a cold cathode;
an anode part disposed opposite to the electron emission part;
a target disposed on a part of a surface of the anode part;
a housing in which the electron emission part, the anode part, and the target are disposed; and
a hydrogen generation part that is made of a material that generates hydrogen when receiving collision of electrons, the hydrogen generation part being disposed on a portion other than a surface of the target out of surfaces existing in the housing.

2. The cold cathode X-ray tube as claimed in claim 1, further comprising a focus structure disposed between the electron emission part and the target,
wherein the hydrogen generation part is disposed on a surface of the focus structure.

3. The cold cathode X-ray tube as claimed in claim 1,
wherein the anode part is made of metal, and
wherein the hydrogen generation part is disposed at a part of a surface of the metal where the target is not disposed.

4. The cold cathode X-ray tube as claimed in claim 1,
wherein at least a part of an inner wall of the housing is made of glass, ceramic, or stainless, and
wherein the hydrogen generation part is disposed on the part of the inner wall.

5. The cold cathode X-ray tube as claimed in claim 1, wherein the hydrogen generation part is made of a silicon nitride film (SiN), a silicon carbide film (SiC), silicon carbonitride film (SiCN), an amorphous carbon film (a-C), or a diamond-like carbon film (DLC).

6. A control method for the cold cathode X-ray tube as claimed in claim 1, comprising injecting hydrogen gas or mixed gas of hydrogen gas and nitrogen gas into the cold cathode X-ray tube when the cold cathode X-ray tube is not operated to adsorb hydrogen to the hydrogen generation part.

7. A control method for the cold cathode X-ray tube as claimed in claim 2, comprising injecting hydrogen gas or mixed gas of hydrogen gas and nitrogen gas into the cold cathode X-ray tube when the cold cathode X-ray tube is not operated to adsorb hydrogen to the hydrogen generation part.
